(19) United States
(12) Patent Application Publication
(10) Pub. No.: US 2006/0038779 A1
(43) Pub. Date: Feb. 23, 2006

(54) Input device containing compartment for retaining an additional electronic device

(76) Inventor: Zu-Nan Li, San Chong (TW)

Correspondence Address: Raymond Sun;Suite 155, 20 Corporate Park, Irvine, CA, 92606, US

(21) Appl. No.: 10/922,059

(22) Filed: Aug. 18, 2004

(51) Int. Cl. G09G 5/08

(52) U.S. Cl. 345/163

(57) ABSTRACT

An input device has a body that includes a plurality of electronic components therein, and a compartment located in the body and isolated from the electronic components. The input device has a main cover mounted on the body, an additional electronic device retained inside the compartment, and a subsidiary cover pivotably coupled to the body and covering the compartment in a closed position.

### BACKGROUND OF THE INVENTION

1. Field of the Invention

The present invention relates to an input device, and in particular, to a wireless input device having a compartment for receiving additional devices.

2. Description of the Prior Art

Input devices, such as computer mice, track balls, joysticks, and game controllers, are becoming essential devices when a user wishes to operate a computer system or the like, so as to accomplish their daily work, communicate with others or entertain themselves. However, no matter how small the input device is, a cable is always required, and occupies space on the often limited working space on a desk, often tangling with the stationery and other computer peripheral devices.

Due to the advancements made in wireless technology, most input devices are becoming wireless. However, once a user carries a wireless input device out of the home or an office, there is no effective place to store the wireless receiver. For example, cramming the wireless receiver into a briefcase will result in the miniaturized receiver being lost sooner or later. Similarly, other popular miniaturized portable storage devices, such as a pen drive, also need a place to be carefully stored and safely protected.

Publication No. US2003/0179177 discloses storing the receiver into an input device having a sliding receptacle 26 so as to firmly secure the receiver into an open chamber 213 at the front side thereof. However, the complicated structure required for this device will increase the production and assembly costs for the input device. In addition, the open chamber 213 is exposed to ambience, thereby exposing batteries and other electronic components to contamination (such as spilled water or coffee).

U.S. Pat. Nos. 6,255,981 and 6,411,281 disclose input devices having a removable cover on top for retaining batteries inside the body of the input device. However, these removable covers can be lost or damaged if used inappropriately.

### SUMMARY OF THE DISCLOSURE

It is an object of the present invention to provide a wireless input device that includes an isolated compartment for receiving an additional electronic device.

It is another object of the present invention to provide a wireless input device that includes an isolated compartment that protects an electronic device held therein from exposure to the ambient environment, thereby avoiding unexpected contamination which may deteriorate the operation of the input device.

It is yet another object of the present invention to provide a wireless input device that includes an isolated compartment for receiving a portable storage device.

In order to accomplish the objects of the present invention, there is provided an input device having a body that includes a plurality of electronic components therein, and a compartment located in the body and isolated from the electronic components. The input device has a main cover mounted on the body, an additional electronic device retained inside the compartment, and a subsidiary cover pivotably coupled to the body and covering the compartment in a closed position.

### BRIEF DESCRIPTION OF THE DRAWINGS

FIG. 1 is an exploded perspective view of one embodiment of an input device according to the present invention.

FIG. 2 is another exploded perspective view of the input device of FIG. 1.

FIG. 3 is an assembled perspective view of the input device of FIG. 1.

FIGS. 4-5 are perspective views of the input device of FIG. 1 showing a wireless receiver being received therein.

FIG. 6 is a cross-sectional view of the input device of FIG. 1 showing how a receiver is removed from the compartment.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

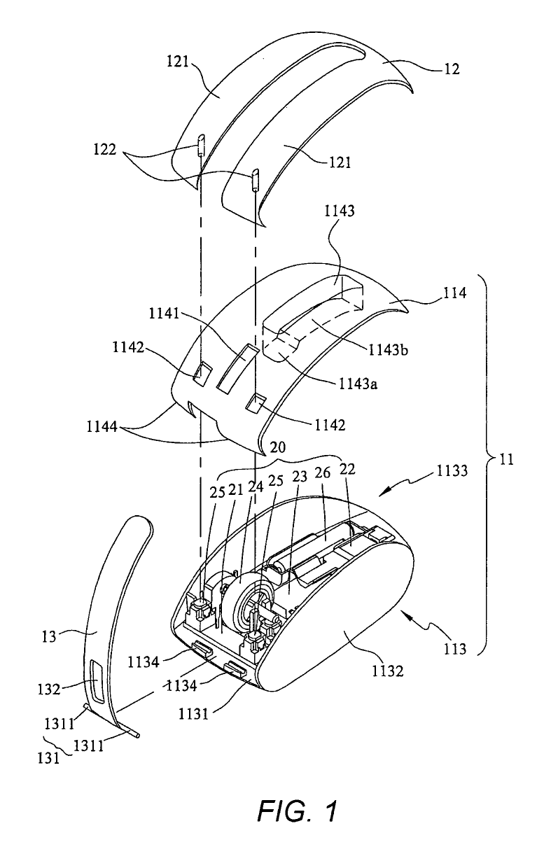

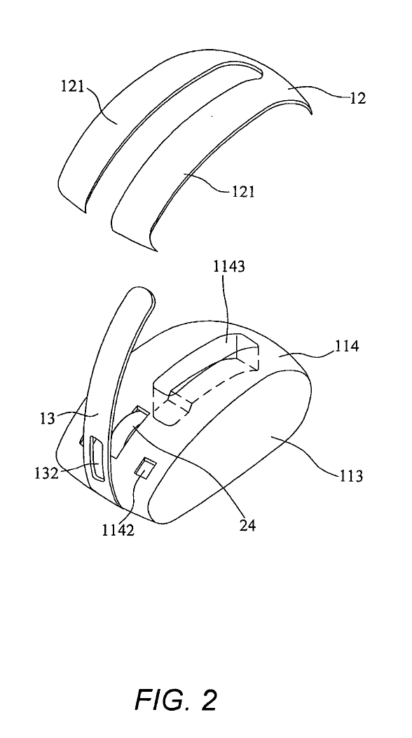

The principles of the present invention are applicable to a wireless input device, which can include, but is not limited to, a computer mouse, a track ball or game pad, among others. Referring to FIGS. 1-3, the input device has a body 10 which has a housing 11 combined by a upper housing 114 and lower housing 113, a main cover 12 and a subsidiary cover 13. The housing 11 has a top 111 and a bottom 112. The lower housing 113 has a front plate 1131 and a pair of lateral plates 1132 so as to form a space 1133 for containing electronic components 20 therein. The lower housing 113 also has a pair of sockets 1134 for coupling to the subsidiary cover 13.

The electronic components 20 can include a PCB 21, a coordinate detecting module including a sensor 22, an encoder 23, a roller 24, several micro-switches 25, and at least one battery 26 for providing power to the entire input device. These various electronic components are well-known in the art, and their structure and operation will not be described in greater detail.

The upper housing 114 has an opening 1141 for allowing a portion of the roller 24 to protrude therethrough, and holes 1142 provided on opposite sides of the opening 1141, with each hole 1142 being positioned to correspond to the position of one of the micro-switches 25. The upper housing 114 also includes an isolated compartment 1143 having a recess 1143a and a storing portion 1143b. The depth of the recess 1143a on the upper housing 114 is greater than that of the storing portion 1143b.

The main cover 12 is integrally mounted on the upper housing 114 and has two buttons 121 at the front end of the cover 12, with each of the buttons 121 having a pin 122 thereunder and extending through corresponding holes 1142. Once a user depresses a button 121, the corresponding pin 122 will be forced to move downward as to activate a corresponding micro-switch 25. In this embodiment, the roller 24 is positioned between the buttons 121.

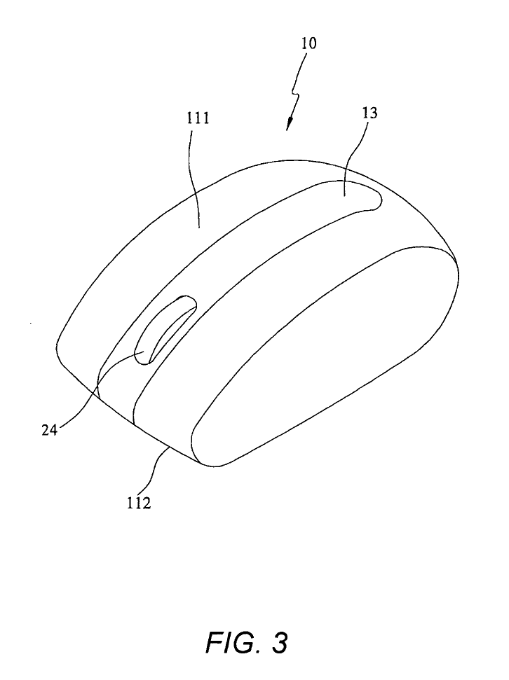

The front end of the subsidiary cover 13 has a pivoting portion 131 which has a extension 1311 at each lateral side. Each extension 1311 can be fitted within a separate socket 1134, and further enclosed by a front end 1144 of the upper housing 114 to enable the subsidiary cover 13 to be pivoted with respect to the housing 11 of the body 10. Using this structural configuration, the subsidiary cover 13 can cover and protect the compartment 1143, as best shown in FIGS. 3-6. An elongated opening 132 can be provided on the subsidiary cover 13 to allow the roller 24 to extend therethrough so that a user can operate the roller 24 from the top 111 of the housing 11.

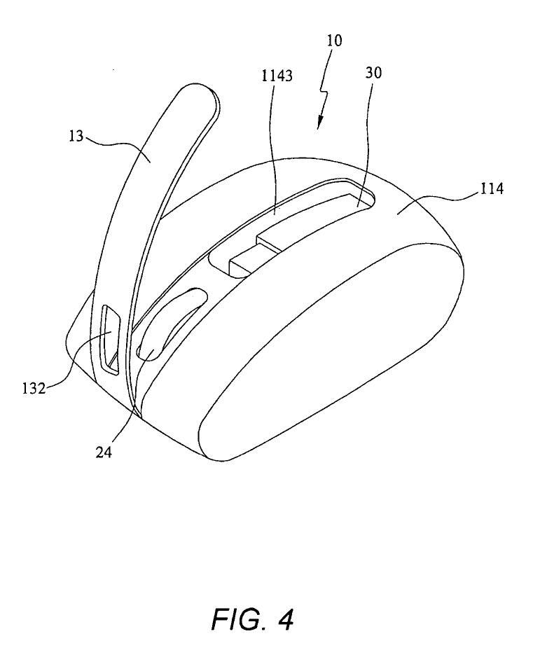

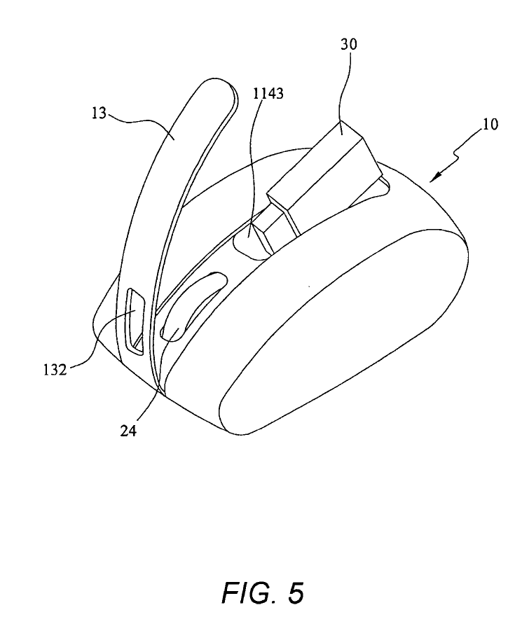

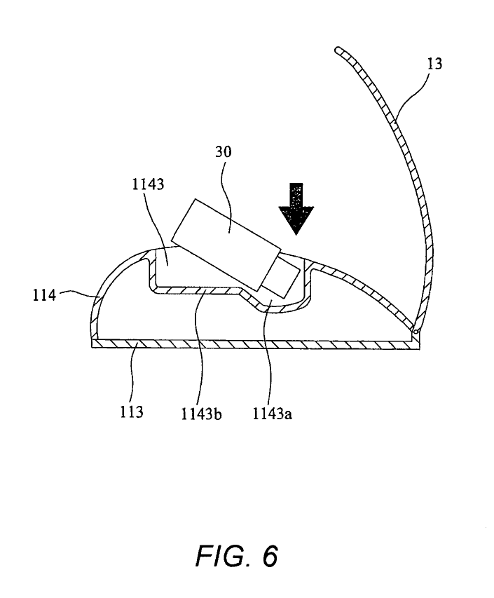

Referring now to FIGS. 4-6, once a user wishes to store a wireless receiver 30 within the compartment 1143, the user merely lifts the subsidiary cover 13 from the rear side towards the front side of the input device. The receiver 30 can be configured to be closely-fitted inside the compartment 1143 so as to avoid unnecessary shaking when the receiver 30 is retained inside the compartment 1143. Because the connector of the receiver 30 at the front of the compartment 1143 is smaller than the rest of the receiver 30, the different depths of the recess 1143a and the storing portion 1143b help to facilitate a more convenient removal of the receiver 30 from the compartment 1143. For example, as soon as the user presses down the connector (see FIGS. 5 and 6), the rear of the receiver 30 will be forced to tilt upward, allowing the user to grip the receiver 30.

It is also possible to provide the subsidiary cover 13 in a manner where it is pivotally coupled to the main cover 12 or the upper housing 114. For example, a protrusion can be provided on the subsidiary cover 13, and a corresponding recess provided on the main cover 12 (or the upper housing 114) to receive the protrusion. Thus, the subsidiary cover 13 can be pivoted from either the upper housing 114, the lower housing 113, or the main cover 12.

Further, it is possible to store in the compartment 1143 a portable storage device (such as a pen drive device) that has a shape that is similar to the shape of the wireless receiver 30.

In addition, the main cover 12 can be cut into two independent (left and right) covers, each having an individual button 121 and rod 122. In this embodiment, the subsidiary cover 13 can still be positioned between the left and right buttons 121.

As yet another alternative, the subsidiary cover 13 can be lifted open not only from the rear side to the front side of the input device, but also from the front side to the rear side of the input device.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An input device, comprising:
a body having a plurality of electronic components therein, and a compartment located in the body and isolated from the electronic components;
a main cover mounted on the body;
an additional electronic device retained inside the compartment; and
a subsidiary cover pivotably coupled to the body and covering the compartment in a closed position.

2. The input device of claim 1, wherein the additional electronic device is a wireless receiver.

3. The input device of claim 1, wherein the additional electronic device is a portable storage device.

4. The input device of claim 1, wherein the compartment has a recess and a storing portion, with the recess having a depth which is deeper than the depth of the storing portion.

5. The input device of claim 1, wherein the electronic components include a printed circuit board (PCB), a coordinated detecting module, a roller and at least one micro-switch.

6. The input device of claim 5, wherein the main cover has two integrally formed buttons, with the roller is located between the buttons.

7. The input device of claim 6, wherein the subsidiary cover is located between the two buttons.

8. The input device of claim 7, wherein the subsidiary cover has an elongated opening for receiving the roller.

9. The input device of claim 5, wherein the main cover further comprises a left cover and a right cover, with each of the left cover and right cover having an integrally-formed button, and wherein the roller is located between the left cover and the right cover.

10. The input device of claim 8, wherein the subsidiary cover is located between the two buttons.

11. The input device of claim 10, wherein the subsidiary cover has an lo elongated opening for receiving the roller.

12. The input device of claim 1, wherein the body has a socket and the subsidiary cover has a pivoting portion coupled to the socket such that the subsidiary cover can pivot about the body.

13. The input device of claim 1, wherein the subsidiary cover is pivoted about the main cover.

14. The input device of claim 1, wherein the body has a housing that includes a upper housing and a lower housing, with the compartment provided in the upper housing.

15. A method for retaining an additional electronic device inside an input device, comprising:
providing a body having a main cover on top;
providing an isolated compartment in the body;
retaining the additional electronic device in the compartment;
pivoting a subsidiary cover to the body; and
causing the subsidiary cover to cover the compartment.

16. The method of claim 15, further including:
providing the main cover with two integrally formed buttons; providing a roller between the two buttons; and
depressing one of the buttons to activate a corresponding micro-switch.

17. The method of claim 15, further including:
providing the main cover with a left cover and a right cover, each cover having a button;
providing a roller between the left and right covers; and
depressing one of the buttons to activate a corresponding micro-switch.

18. The method of claim 15, wherein the subsidiary cover is pivotably coupled to the main cover.
